(19) United States
(12) Patent Application Publication
(10) Pub. No.: US 2026/0308348 A1
(43) Pub. Date: Oct. 8, 2026

(54) SOUND ABSORPTION MATERIAL AND METHOD OF FABRICATING SAME

(71) Applicant: Agency for Science, Technology and Research, Singapore (SG)

(72) Inventors: Kui YAO, Singapore (SG); Yasmin MOHAMED YOUSRY, Singapore (SG); Shu Ting CHEN, Singapore (SG); Poh Chong LIM, Singapore (SG)

(21) Appl. No.: 18/996,668

(22) PCT Filed: Jul. 10, 2023
(86) PCT No.: PCT/SG2023/050481

§ 371 Date: Jan. 17, 2025

(30) Foreign Application Priority Data
Jul. 18, 2022 (SG) 10202250499C

(51) Int. Cl. C08J 9/35; C08F 14/22; C08K 3/04; C08K 3/08; G10K 11/162

(52) U.S. Cl. CPC C08J 9/35; C08F 14/22; C08K 3/041; C08K 3/042; C08K 3/08; G10K 11/162; C08K 2003/0806

(57) ABSTRACT

A sound absorption material and a method (10) of fabricating a sound absorption material are provided. The method (10) includes preparing (12) a first precursor solution or suspension of one of a first triboelectric material and a second triboelectric material; and forming (16) a porous structure by using the first precursor solution or suspension in one of a templating technique with a second precursor solution or suspension of the other one of the first and second triboelectric material, an immersion technique with the other one of the first and second triboelectric materials, and an electrospinning technique with the other one of the first and second triboelectric materials. The porous structure includes a hybrid composite of the first triboelectric material having a first charge affinity and the second triboelectric material having a second charge affinity, wherein the first charge affinity is greater than the second charge affinity.

### FIELD OF THE INVENTION

The present invention relates in general to noise mitigation and more particularly to a sound absorption material and a method of fabricating the same.

### BACKGROUND OF THE INVENTION

Noise pollution significantly affects quality of life. Hence, airborne acoustic absorbers that effectively suppress undesirable background noise provide a more comfortable ambient environment.

Sound absorption coefficient of a material represents a ratio of absorbed energy to incident energy. Accordingly, a higher sound absorption coefficient is indicative of more sound being absorbed with less reflection or transmission. However, the efficiency of commercially available sound absorption materials is limited at a low frequency range of less than 2 kilohertz (kHz), which is the frequency range at which most ambient noise in urban environments from traffic, industry and construction is at.

To overcome the lack of efficiency at low frequency, various techniques have been proposed in the last decade.

Multi-layered sound configurations offer an improved acoustic absorption performance. However, the required thickness of these configurations is high at around 100 millimetres (mm) to 150 mm, which is bulky and costly.

As an alternative, hybrid sound absorption techniques have also been developed which include porous materials for a mid- to high-frequency range and a separate active control system to act at a low frequency range. However, these solutions require external power supplies and control systems which increases complexity and cost.

Materials with enhanced sound absorption performance at low frequency and that can be produced by inexpensive, scalable fabrication methods are thus in demand.

### SUMMARY OF THE INVENTION

Accordingly, in a first aspect, the present invention provides a sound absorption material. The sound absorption material includes a porous structure. The porous structure includes a hybrid composite of a first triboelectric material having a first charge affinity and a second triboelectric material having a second charge affinity, wherein the first charge affinity is greater than the second charge affinity.

In a second aspect, the present invention provides a method of fabricating a sound absorption material. The method includes preparing a first precursor solution or suspension of one of a first triboelectric material and a second triboelectric material; and forming a porous structure by using the first precursor solution or suspension in one of a templating technique with a second precursor solution or suspension of the other one of the first and second triboelectric material, an immersion technique with the other one of the first and second triboelectric materials, and an electrospinning technique with the other one of the first and second triboelectric materials. The porous structure includes a hybrid composite of the first triboelectric material having a first charge affinity and the second triboelectric material having a second charge affinity, wherein the first charge affinity is greater than the second charge affinity.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1 is a schematic flow diagram illustrating a method of fabricating a sound absorption material in accordance with an embodiment of the present invention;

FIG. 2 is a schematic diagram illustrating energy conversion mechanisms of a sound absorption material in accordance an embodiment of the present invention;

FIG. 3A is a schematic diagram illustrating a method of fabricating a PVDF/MWCNT/glass fibres composite foam using a salt template method;

FIG. 3B is a graph of acoustic absorption coefficients of prepared PVDF/glass fibres and PVDF/MWCNT/glass fibres composite foams in comparison with a pure PVDF foam and a glass wool acoustic absorber sample;

FIG. 4A is a schematic diagram illustrating a fabrication method for a PVDF/MWCNT-modified glass wool porous composite;

FIG. 4B is a graph of acoustic absorption coefficients of prepared PVDF-modified glass wool and PVDF/MWCNT-modified glass wool porous composites in comparison with pure PVDF and pure glass wool;

FIG. 5A is a schematic diagram illustrating a fabrication method for a PVDF electrospun fibre-coated glass wool porous composite;

FIG. 5B is a graph of acoustic absorption coefficients of a PVDF electrospun fibre-coated glass wool and a PVDF/MWCNT electrospun fibre-coated glass wool in comparison with a glass wool acoustic absorber sample;

FIG. 6 is a graph of acoustic absorption coefficients of a PS electrospun fibre-coated glass wool and a PS/MWCNT electrospun fibre-coated glass wool in comparison with a glass wool acoustic absorber sample; and

FIG. 7 is a schematic diagram illustrating a fabrication method for a porous triboelectric composite using an electrospinning process with two (2) spinnerets.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

The term “precursor” as used herein refers to a substance from which another is formed. Accordingly, the term “precursor solution” as used herein refers to a homogeneous mixture of a solvent and a precursor solute and the term “precursor suspension” as used herein refers to a heterogeneous mixture of a solvent and a precursor solute.

The term “triboelectric material” as used herein refers to a dielectric material with a tendency to lose or gain static electrical charges on its surfaces when physical contact and relative movements arise. Examples of triboelectric materials include, but are not limited to, polymethyl methacrylate (PMMA), poly(L-lactide) (PLLA), polycarbonate (PC), polyurethane (PU), poly[imino(1,6-dioxohexamethylene) iminohexamethylene], cotton, glass wool, polyimide (PI), polystyrene (PS), polypropylene (PP), polyethylene (PE), polyacrylonitrile (PAN), polyvinylpyrrolidone (PVP), polyvinyl chloride (PVC), and polyvinylidene fluoride (PVDF).

The term “piezoelectric material” as used herein refers to a material or substance that is capable of converting mechanical energy into electrical energy. Examples of piezoelectric materials include, but are not limited to, a polyvinylidene fluoride (PVDF) homopolymer, a PVDF-based copolymer, poly(vinylidene fluoride trifluoroethylene), a poly(vinylidene fluoride-hexafluoropropylene) copolymer, poly(vinylidene fluoride-trifluoroethylene-chlorofluoroethylene) terpolymer, and poly(L-lactide) (PLLA).

The term “homopolymer” as used herein refers to a polymer made from many copies of a single repeating unit and the term “copolymer” as used herein refers to a polymer derived from more than one repeating unit.

The term “hybrid composite” as used herein refers to a composite material made from a combination of two or more different types of triboelectric materials.

The term “percolation threshold” as used herein refers to a concentration point at which conductivity of a composite increases dramatically with increasing concentration of conductive material as particles of the conductive material become connected with one another, forming a long-range conducting network. When a concentration of the electrically conductive material in a composite is too low, the conductive material is isolated in the non-conductive matrix and overall conductivity does not increase significantly with increasing concentration of the electrically conductive material. Beyond the percolation threshold, further addition of conductive constituents leads to a levelling of the conductivity. The percolation threshold may be experimentally determined by measuring resistivity or conductivity of the composite at different concentrations of the conducting material.

The term “charge affinity” as used herein refers to a degree to which a material gains or loses charges from another material. Accordingly, the term “positive charge affinity” as used herein refers to having a stronger affinity for positive charges such that a material tends to lose electrons and the term “negative charge affinity” as used herein refers to having a stronger affinity for negative charges such that a material tends to gain electrons.

The term “mixed solvent” as used herein refers to a blend of two or more miscible liquids.

The term “templating technique” as used herein refers to a fabrication method to produce a porous structure involving use of a substance such as sugar or salt as a sacrificial matter to create pores within the structure. The fabrication method begins by mixing the sugar or salt with a polymer solution to create a mixture that is poured or cast into a mould. Once the mixture is solidified, the sugar or salt is removed by washing the solidified mixture with water or a solvent that dissolves the sugar or salt. This leaves behind the porous structure with pores where the sugar or salt was previously located.

The term “immersion technique” as used herein refers to a fabrication method to produce a porous composite structure by dipping or submerging a porous material into a polymer solution.

The term “electrospinning technique” as used herein refers to a fabrication method to produce a nano- or micro-fibre network by applying an electric field to a polymer or ceramic solution or melt. Accordingly, the term “electrospun fibre” as used herein refers to a nano- or micro-fibre having a diameter ranging from nanometres to micrometres produced by the electrospinning method.

The term “porogen” as used herein refers to a quantity of particles used to make pores in a moulded structure. Examples of porogens include, but are not limited to, baker's salt and sugar.

The term “mass ratio” as used herein refers to a ratio between masses of two substances.

The term “sound absorption coefficient” as used herein refers to a ratio of absorbed energy to incident energy of a material.

The term “about” as used herein refers to both numbers in a range of numerals and is also used to indicate that a value includes the standard deviation of error for the device or method being employed to determine the value. The term “about” as used herein can allow for a degree of variability in a value or range, for example, within 10%, within 5%, or within 1% of a stated value or of a stated limit of a range.

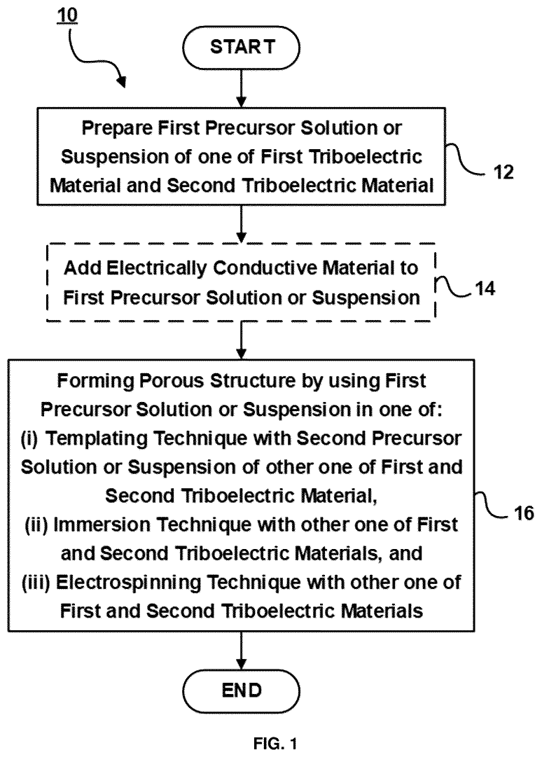

Referring now to FIG. 1, a method 10 of fabricating a sound absorption material is shown. The method 10 begins at step 12 by preparing a first precursor solution or suspension of one of a first triboelectric material and a second triboelectric material. The first triboelectric material may be polymethyl methacrylate (PMMA), poly(L-lactide) (PLLA), polycarbonate (PC), polyurethane (PU), poly[imino(1,6-dioxohexamethylene) iminohexamethylene] (Nylon 6,6), cotton, or glass wool. The second triboelectric material may be polyimide (PI), polystyrene (PS), polypropylene (PP), polyethylene (PE), polyacrylonitrile (PAN), polyvinylpyrrolidone (PVP), polyvinyl chloride (PVC), or polyvinylidene fluoride (PVDF).

At least one of the first and second triboelectric materials may be a piezoelectric material. The piezoelectric material may be a polyvinylidene fluoride (PVDF) homopolymer, a PVDF-based copolymer, poly(vinylidene fluoride trifluoroethylene), a poly(vinylidene fluoride-hexafluoropropylene) copolymer, poly(vinylidene fluoride-trifluoroethylene-chlorofluoroethylene) terpolymer, or poly(L-lactide) (PLLA).

The first triboelectric material may have a positive charge affinity and the second triboelectric material may have a negative charge affinity.

The first precursor solution or suspension of a negative triboelectric material such as, for example, a PVDF polymer, may be prepared by dissolving a polymer powder of PVDF (1 to 25 wt %) in a mixed solvent.

At step 14, an electrically conductive material may be added to the first precursor solution or suspension. This may be by mixing the first precursor solution or suspension with the electrically conductive material. The electrically conductive material may be single-walled carbon nanotubes (SWCNTs), multi-walled carbon nanotubes (MWCNTs), graphene, carbon black, silver nanowires, metal particles or a combination thereof. As an example, a conducting material such as, for example, MWCNT (3 to 9 wt %) may be added to the first precursor solution or suspension to prepare a desired composite suspension.

At step 16, a porous structure is formed by using the first precursor solution or suspension in one of a templating technique with a second precursor solution or suspension of the other one of the first and second triboelectric material, an immersion technique with the other one of the first and second triboelectric materials, and an electrospinning technique with the other one of the first and second triboelectric materials. The porous structure includes a hybrid composite of the first triboelectric material having a first charge affinity and the second triboelectric material having a second charge affinity, the first charge affinity being greater than the second charge affinity.

According to a triboelectric series, a smallest difference in charge affinity between triboelectric pairs such as, for example, PVC-PP is about 10 nano-Coulomb per Joule (nC/J) and a largest difference is about 250 nC/J such as, for example, between Teflon and PU. Accordingly, a difference between the first and second charge affinities may be between about 10 nano-Coulomb per Joule (nC/J) and about 250 nC/J. To maximise airborne acoustic absorption, the difference between the first and second charge affinities may be between about 200 nC/J and about 250 nC/J.

The combinations of pairs of triboelectric materials are designed with a large difference in their charge affinities in the porous structure. The first and second triboelectric materials may be a triboelectric pair such as, for example, PVDF-glass wool, PVDF-poly[imino(1,6-dioxohexamethylene) iminohexamethylene], PVDF-PE, PVDF-PP, PVDF-PLLA, PVDF-PMMA, PVC-glass wool, PVC-poly[imino(1,6-dioxohexamethylene) iminohexamethylene], PVC-PU, PVC-PE, PVC-PP, PVC-PLLA, PVC-PMMA, PVA-glass wool, PVA-poly[imino(1,6-dioxohexamethylene) iminohexamethylene], PVA-PU, PVA-PE, PVA-PP, PVA-PLLA, PVA-PMMA, PAN-glass wool, PAN-poly[imino(1,6-dioxohexamethylene) iminohexamethylene], PAN-PU, PAN-PE, PAN-PP, PAN-PLLA, PAN-PMMA, PS-glass wool, PS-poly[imino(1,6-dioxohexamethylene) iminohexamethylene], PS-PU, PS-PE, PS-PP, PS-PLLA, PS-PMMA, PC-glass wool, PC-poly[imino(1,6-dioxohexamethylene) iminohexamethylene], PC-PU, PC-PE, PC-PP, PC-PLLA, PC-PMMA, PI-glass wool, PI-poly[imino(1,6-dioxohexamethylene) iminohexamethylene] (Nylon 6,6), PI-PU, PI-PE, PI-PP, PI-PLLA, PI-PMMA, glass wool-PP, or poly[imino(1,6-dioxohexamethylene) iminohexamethylene]-PP.

A porous composite may be formed by salt/sugar template, immersion, or electrospinning techniques, in particular, by mixing, immersing, or electrospinning the first precursor solution or suspension with a positive or negative triboelectric material with substantially different charge affinity than the first precursor solution or suspension.

In the salt/sugar template technique, the step of forming the porous structure using the first precursor solution or suspension in the templating technique with a second precursor solution or suspension of the other one of the first and second triboelectric material may include: preparing the second precursor solution or suspension of the other one of the first triboelectric material and the second triboelectric material; mixing the first precursor solution or suspension and the second precursor solution or suspension to form a first mixture; mixing a porogen into the first mixture to form a second mixture;

performing a moulding operation using the second mixture to produce the hybrid composite; and dissolving the porogen to obtain the porous structure.

The porogen may be a salt or a sugar. A mass ratio of the second triboelectric material to the porogen may be between about 8:92 and about 10:90.

In one or more embodiments, a porous composite may be produced by mixing a negative triboelectric material such as, for example, PVDF and a positive triboelectric material such as, for example, glass fibres with a conducting material such as, for example, MWCNT using a salt template method. In such an embodiment, a polymer solution may be mixed with the positive triboelectric material of chopped glass fibres (1 to 25 wt % in a solid polymer powder) from a glass wool sample and MWCNT (3 to 9 wt %), which serves as the conducting material, to prepare a desired composite solution. The porous composite may be formed by mixing sugar or salt with the composite solution until a soft dough is formed. The mixture may be formed using a mould. The samples may then be dried in an oven, followed by thermal annealing to get a porous composite foam as an airborne acoustic absorber.

In the immersing technique, the step of forming the porous structure using the first precursor solution or suspension in the immersion technique with the other one of the first and second triboelectric materials may include: immersing the first triboelectric material in the first precursor solution or suspension, the first precursor solution or suspension being of the second triboelectric material.

In one or more embodiments, a porous composite may be produced by immersing a positive triboelectric material such as, for example, a fibrous glass wool in a precursor solution or suspension of a negative triboelectric material such as, for example, PVDF and a conducting material such as, for example, MWCNT. In such an embodiment, the porous composite may be fabricated by immersing a porous triboelectric material in a selected polymer solution containing the conducting material. The porous triboelectric composite may then be dried in an oven, followed by thermal annealing.

In the electrospinning technique, the step of forming the porous structure using the first precursor solution or suspension in the electrospinning technique with the other one of the first and second triboelectric materials may include: electrospinning the first precursor solution or suspension to generate a plurality of first electrospun fibres; and depositing the first electrospun fibres through an electric field onto the other one of the first and second triboelectric materials to cover a plurality of surfaces of the other one of the first and second triboelectric materials, the first electrospun fibres diffusing into a plurality of pores of the other one of the first and second triboelectric materials. The first precursor solution or suspension may be of the second triboelectric material and the first electrospun fibres may be deposited onto the first triboelectric material.

In one or more embodiments, a porous composite for airborne acoustic absorption may be produced by electrospinning of a first triboelectric material with a conducting material to form electrospun fibres and diffusing the electrospun fibres to a porous structure of a second triboelectric material. As an example, the porous composite may be produced by electrospinning of a precursor solution or suspension containing a negative triboelectric material such as, for example, PVDF and a conducting material such as, for example, MWCNT on a porous structure of a positive triboelectric material such as, for example, glass wool. As another example, the porous composite may be produced by electrospinning of a precursor solution or suspension containing a negative triboelectric material such as, for example, PS and a conducting material such as, for example, MWCNT on a porous structure of a positive triboelectric material such as, for example, glass wool.

In an alternative electrospinning technique, the step of forming the porous structure using the first precursor solution or suspension in the electrospinning technique with the other one of the first and second triboelectric materials may include: preparing the second precursor solution or suspension of the other one of the first triboelectric material and the second triboelectric material; electrospinning the first precursor solution or suspension to generate a plurality of first electrospun fibres; electrospinning the second precursor solution or suspension to generate a plurality of second electrospun fibres; and depositing the first and second electrospun fibres through an electric field onto a substrate to produce the hybrid composite. The electrospinning of the triboelectric materials allows two (2) kinds of fibrous materials (positive and negative triboelectric materials) to diffuse among each other.

In one or more embodiments, a porous composite for airborne acoustic absorption may be produced by electrospinning a positive and negative triboelectric pair of materials with a conducting material.

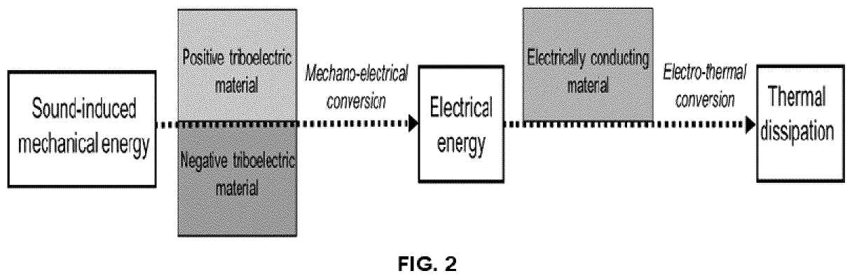

Having described the method 10 of fabricating a sound absorption material, the sound absorption material thus formed will next be described with reference to FIG. 2 illustrating energy conversion mechanisms of the sound absorption material. More particularly, FIG. 2 schematically illustrates combined energy conversion mechanisms involved in the sound absorbing process of the porous triboelectric composite.

The sound absorption material includes a porous structure. The porous structure includes a hybrid composite of a first triboelectric material having a first charge affinity and a second triboelectric material having a second charge affinity, wherein the first charge affinity is greater than the second charge affinity.

Physical contact and relative movement between the first and second triboelectric materials arise in the porous composite from excitation by airborne acoustic waves at a low frequency region (<1000 Hz) which causes mechanical vibrations. As can be seen from FIG. 2, mechanical energy of the acoustic waves is then converted into electrical energy through the triboelectric effect.

The first triboelectric material may be polymethyl methacrylate (PMMA), poly(L-lactide) (PLLA), polycarbonate (PC), polyurethane (PU), poly[imino(1,6-dioxohexamethylene) iminohexamethylene], cotton, or glass wool. The second triboelectric material may be polyimide (PI), polystyrene (PS), polypropylene (PP), polyethylene (PE), polyacrylonitrile (PAN), polyvinylpyrrolidone (PVP), polyvinyl chloride (PVC), or polyvinylidene fluoride (PVDF). A concentration of one of the first and second triboelectric materials in the hybrid composite may be between about 1 wt % and about 25 wt % of the hybrid composite.

A difference between the first and second charge affinities may be between about 10 nano-Coulomb per Joule (nC/J) and about 250 nC/J. To maximise airborne acoustic absorption, the difference between the first and second charge affinities may be between about 200 nC/J and about 250 nC/J. Advantageously, a combination of pairs of triboelectric materials with a large difference in charge affinities broadens a frequency bandwidth for high acoustic absorption.

Accordingly, combinations of pairs of triboelectric materials may be selected with a large difference in charge affinities in the porous structure to maximize generation of triboelectric charges from physical contact and relative movement between the triboelectric materials from excitation of airborne acoustic waves at low frequency region (<1000 Hz) which causes mechanical vibrations.

The first triboelectric material may have a positive charge affinity and the second triboelectric material may have a negative charge affinity.

A positive triboelectric material can generate and lose static charges upon contacting a negative triboelectric material as the positive triboelectric material tends to generate and lose electrons when coming into contact with the negative triboelectric material. The negative triboelectric material can gain static charges upon contacting the positive triboelectric material as the negative triboelectric material tends to gain electrons when coming into contact with the positive triboelectric material.

A negative triboelectric material that tends to gain electrons has stronger affinity for negative charges and its surface becomes negatively charged after the surface contacts a positive triboelectric material and is separated. Conversely, a positive triboelectric material that tends to lose electrons has weaker affinity for negative charges and its surface becomes positively charged after the surface contacts a negative triboelectric material and is separated.

Table 1 below may be used to select a pair of positive and negative triboelectric materials with a large difference in electron affinities to maximize charge generation upon contacting each other. Positive and negative in this context are relative to each other. For example, a PVDF polymer may be used as a negative triboelectric material if contacted with a material that has a lower electron affinity value, while the same PVDF polymer may be used as a positive triboelectric material if contacted with a material that has a higher electron affinity value.

TABLE 1
Electron affinity of various dielectric materials

| Material | Affinity (nC/J) |
|---|---|
| Mica | +60 |
| Hair | +45 |
| Polyurethane | +40 |
| Nylon 6,6 | +30 |
| Glass (soda) | +25 |
| Paper (uncoated copy) | +10 |
| Nitrile rubber | +3 |
| Cotton | 0 |
| Polycarbonate | −5 |
| Acrylonitrile butadiene styrene (ABS) | −8 |
| Poly (methyl methacrylate) (PMMA) | −10 |
| Styrene-butadiene rubber (SBR) | −35 |
| Polyethylene terephthalate (PET) | −40 |
| Polystyrene (PS) | −50 |
| Polyimide (PI) | −55 |
| Polyvinyl ether (PVE) | −62 |
| Polyvinylpyrrolidone (PVP) | −72 |
| Polyvinylidene fluoride (PVDF) | −76 |
| Polyethylene (PE) | −85 |
| Polypropylene (PP) | −90 |
| Polychloroprene | −98 |
| Polyvinyl chloride (PVC) | −100 |
| Teflon | −190 |

Table 2 below may be used to select positive and negative triboelectric materials that maximize static charging based on respective tendencies to gain or lose electrons as provided from the electron affinity values in Table 1. For example, polyvinyl chloride (PVC) with a negative charge affinity value of −100 nC/J may be used against polyurethane (PU) with a positive charge affinity value of +40 nC/J and this will generate about 140 nC of charge transfer per joule of energy upon contact due to relative movement of the two triboelectric materials.

TABLE 2
Positive and negative triboelectric materials selected for fabrication
of porous triboelectric composite for acoustic absorption

| Positive triboelectric materials | Negative triboelectric materials |
|---|---|
| with tendency to lose electrons | with tendency to gain electrons |
| Poly (methyl methacrylate) (PMMA) | Polyvinylidene fluoride (PVDF) |
| Poly(L-lactide) (PLLA) | Polyvinyl chloride (PVC) |
| Polycarbonate (PC) | Polyvinylpyrrolidone (PVP) |
| Polyurethane (PU) | Polyacrylonitrile (PAN) |
| Poly[imino(1,6-dioxohexamethylene) | Polystyrene (PS) |
| iminohexamethylene] (Nylon 6,6) | |
| Cotton | Polyethylene (PE) |
| Glass wool | Polypropylene (PP) |

Accordingly, the first and second triboelectric materials may be a triboelectric pair such as, for example, PVDF-glass wool, PVDF-poly[imino(1,6-dioxohexamethylene) iminohexamethylene], PVDF-PE, PVDF-PP, PVDF-PLLA, PVDF-PMMA, PVC-glass wool, PVC-poly[imino(1,6-dioxohexamethylene) iminohexamethylene], PVC-PU, PVC-PE, PVC-PP, PVC-PLLA, PVC-PMMA, PVA-glass wool, PVA-poly[imino(1,6-dioxohexamethylene) iminohexamethylene], PVA-PU, PVA-PE, PVA-PP, PVA-PLLA, PVA-PMMA, PAN-glass wool, PAN-poly[imino(1,6-dioxohexamethylene) iminohexamethylene], PAN-PU, PAN-PE, PAN-PP, PAN-PLLA, PAN-PMMA, PS-glass wool, PS-poly[imino(1,6-dioxohexamethylene) iminohexamethylene], PS-PU, PS-PE, PS-PP, PS-PLLA, PS-PMMA, PC-glass wool, PC-poly[imino(1,6-dioxohexamethylene) iminohexamethylene], PC-PU, PC-PE, PC-PP, PC-PLLA, PC-PMMA, PI-glass wool, PI-poly[imino(1,6-dioxohexamethylene) iminohexamethylene], PI-PU, PI-PE, PI-PP, PI-PLLA, PI-PMMA, glass wool-PP, or poly[imino(1,6-dioxohexamethylene) iminohexamethylene]-PP.

At least one of the first and second triboelectric materials may be a piezoelectric material. Advantageously, piezoelectric properties in the triboelectric materials can enhance the performance of charge generation and sound absorption due to the additional effect of converting mechanical energy to electrical energy through strong piezoelectricity, especially at relatively higher frequency. Accordingly, when one of the first and second triboelectric materials is a piezoelectric polymer, there is an additional effect of converting mechanical energy to electrical energy through a piezoelectric effect.

The piezoelectric material may be a polyvinylidene fluoride (PVDF) homopolymer, a PVDF-based copolymer, poly(vinylidene fluoride trifluoroethylene), a poly(vinylidene fluoride-hexafluoropropylene) copolymer, poly(vinylidene fluoride-trifluoroethylene-chlorofluoroethylene) terpolymer, or poly(L-lactide) (PLLA). A concentration of the piezoelectric material in the hybrid composite may be between about 1 percentage by mass (wt %) and about 25 wt % of the hybrid composite.

The hybrid composite may further include an electrically conductive material providing an electrically conductive network within the porous structure. Electrical discharge can take place through the conductive network added to the composite as the electrically conducting material allows electrical charges generated in the triboelectric materials to discharge through the conductive network, converting the generated electrical energy into thermal dissipation. Advantageously, hybridization of triboelectric materials for charge generation with the electrically conducting material for electric discharge offers an efficient approach to enhance sound absorption at low frequencies and over a broad frequency regime. The electrically conductive material may be single-walled carbon nanotubes (SWCNTs), multi-walled carbon nanotubes (MWCNTs), graphene, carbon black, silver nanowires, metal particles or a combination thereof. A concentration of the electrically conductive material in the hybrid composite may be at or above a percolation threshold because when the concentration of the electrically conductive material in the composite is too low, the conductive material is isolated in a non-conductive matrix and overall conductivity does not increase significantly with increasing content of electrically conductive material. However, when the concentration of the conducting material satisfies the percolation threshold, the conductivity of the composite increases dramatically with increasing conductive material content as particles of the conductive material are connected with one another, forming a long-range conducting network. Further addition of conductive constituent leads to a levelling of conductivity. The percolation threshold may be determined experimentally by measuring the resistivity/conductivity of the composite at different concentrations of the conducting material. In one or more embodiments, the concentration of the electrically conductive material in the hybrid composite may be between about 3 percentage by mass (wt %) and about 9 wt % of the first and second triboelectric materials.

A sound absorption coefficient of the hybrid composite as measured according to an ASTM E1050-19 procedure utilizing a standard acoustic tube (Bruel & Kjaer) with a sample thickness of 25 millimetres (mm) and diameter of 100 mm may be greater than about 50% at frequencies higher than between about 550 Hertz (Hz) and about 570 Hz in an audible range. The sound absorption coefficient of the hybrid composite as measured according to the ASTM E1050-19 procedure utilizing the standard acoustic tube (Bruel & Kjaer) with the sample thickness of 25 millimetres (mm) and diameter of 100 mm may be greater than about 90% at frequencies higher than 1 kiloHertz (kHz) in the audible range. In an embodiment where the porous composite comprises PVDF-glass wool as the negative and positive triboelectric pair and MWCNT as the electrically conducting material, a sound absorption coefficient of above 50% at frequencies higher than 550 Hz and above 90% at frequencies higher than 1 kHz in the audible range with a thickness of 25 mm is achievable. In another embodiment where the porous composite comprises PS-glass wool as the negative and positive triboelectric pair and MWCNT as the electrically conducting material, a sound absorption coefficient of above 50% at frequencies higher than 570 Hz and above 90% at frequencies higher than 1 kHz in the audible range with a thickness of 25 mm is achievable.

Experimental Results

### Example 1

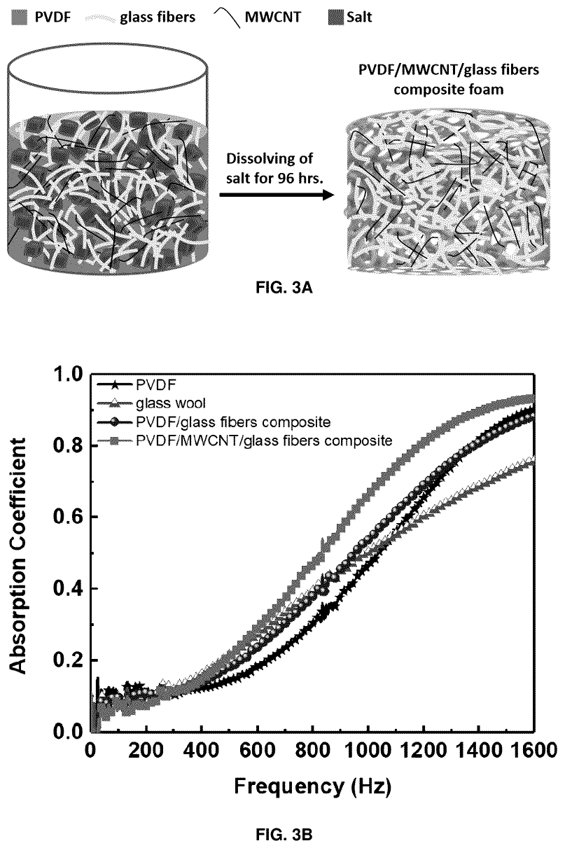

Referring now to FIG. 3A, a porous composite foam was prepared using a salt template method as shown. Polyvinylidene fluoride (PVDF) having an electron affinity of −75 nano-Coulomb per Joule (nC/J) was used as the negative triboelectric material, while a glass wool with an electron affinity of +25 nC/J was used as the positive triboelectric material.

A 5 wt % PVDF solution was prepared by dissolving PVDF in a mixed N,N-dimethylformamide (DMF) and acetone solvent (50:50 by volume) in a silicone oil bath at 60 degrees Celsius (° C.). Multi-walled carbon nanotubes (MWCNTs) with a concentration of 7 wt % (in the solid PVDF powder) were added to the solution to satisfy a percolation threshold. The conductive MWCNTs in the foam were connected to each other, creating a long-range three-dimensional conducting network. Hence, conductivity could be effectively realized.

A glass wool material was chopped into fine glass fibres and then dispersed in the mixed DMF and acetone solvent and sonicated in an ultrasonic bath.

After that, both PVDF/MWCNT and the glass fibres suspensions were mixed, sonicated, and heated at 60° C. to obtain a precursor suspension.

Foams were prepared by mixing the PVDF/glass fibres or PVDF/MWCNT/glass fibres suspensions with baker's salt (different sizes of particles; preferably 0.2 mm-0.6 mm in diameter) and the mixtures were poured into cylindrical moulds which had similar geometrical shapes to a standard impedance tube (thickness of 25 mm and diameter of 100 mm), as shown in FIG. 3A. The porosity was adjusted by controlling the mass ratio of PVDF and salt to be approximately 8:92 for all the prepared foams. The moulded foams were dried in an oven at 100° C. to remove excess solvents and ensure complete drying.

Afterward, the foams were removed from the moulds and placed in repeated cycles of hot water for 96 hours to dissolve the salt and obtain the porous composite foams. The porous composite foams were then dried at 100° C. for 12 hours in an oven, followed by thermal annealing at 135° C. for 24 hours.

Referring now to FIG. 3B, sound absorption coefficients of the porous composites were measured according to the ASTM E1050-19 procedure utilizing a standard acoustic tube (Bruel & Kjaer) with a sample thickness of 25 mm and diameter of 100 mm. Acoustic absorption coefficients of a pure PVDF foam, a PVDF/glass fibres composite, a PVDF/MWCNT/glass fibres composite and a glass wool acoustic absorber sample were compared as shown in FIG. 3B. As can be seen from FIG. 3B, the acoustic absorption coefficient of the PVDF/MWCNT/glass fibres composite is the highest. In addition to conventional acoustic energy dissipation mechanisms, such as fluid viscosity, thermal losses, and visco-elastic structural damping, the porous layers displayed a rough surface with gaps between the solid parts providing relative movements between the dielectric materials from excitation of airborne acoustic waves that make mechanical vibrations in the porous structure. This relative movement at a low frequency region (<1000 Hz) leads to triboelectric charge generation from a contact electrification effect and electrical discharge can take place through the conductive network so that the electrical energy can be converted into thermal dissipation. Besides being a negative triboelectric material, PVDF has a piezoelectric effect enabling it to convert mechanical energy including sound energy into electrical energy, more relatively at a higher frequency region (>1000 Hz).

### Example 2

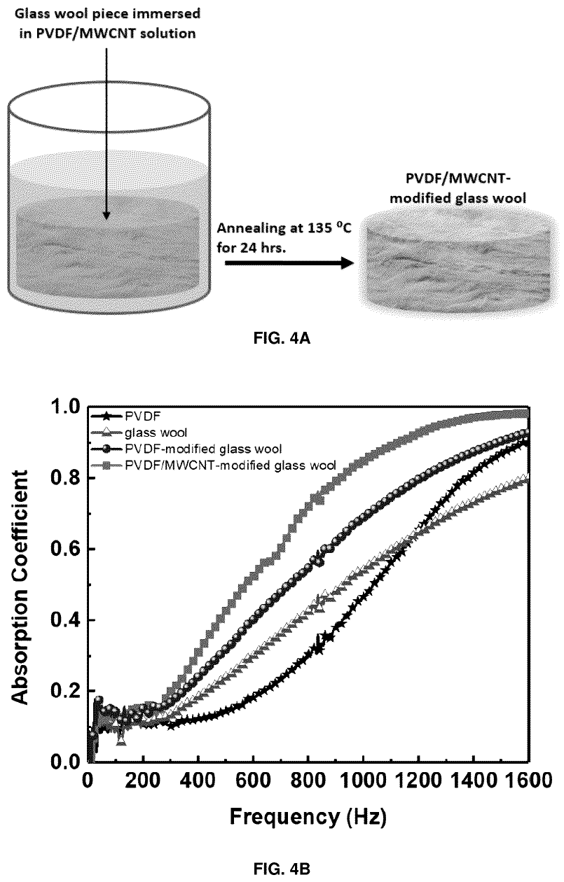

Referring now to FIG. 4A, a fabrication method for a PVDF/MWCNT-modified glass wool porous composite is shown.

A polymer solution containing the negative triboelectric PVDF was prepared by dissolving 5 wt % PVDF in a mixed DMF and acetone solvent (50:50 by volume) in a silicone oil bath at 60° C. MWCNTs with a concentration of 7 wt % (in the solid PVDF powder) were added to the polymer solution to satisfy the percolation threshold.

A porous glass wool sample as a positive triboelectric material was directly immersed in the prepared polymer suspension to form a porous composite, as shown in FIG. 4A. The PVDF/MWCNT-modified glass wool sample was then annealed at 135° C. for 24 hours.

This method is scalable at low cost by eliminating the amount of water used for leaching the salt as described in Example 1.

Referring now to FIG. 4B, sound absorption coefficients of the porous composites were measured according to the ASTM E1050-19 procedure utilizing a standard acoustic tube (Bruel & Kjaer) with a sample thickness of 25 mm and diameter of 100 mm. The acoustic absorption coefficients of the prepared PVDF-modified glass wool and PVDF/MWCNT-modified glass wool porous composites compared to pure PVDF and glass wool samples are shown in FIG. 4B. As can be seen from FIG. 4B, the acoustic absorption coefficient of the PVDF/MWCNT-modified glass wool is the highest and is able to reach more than 50% at frequencies higher than 550 Hz in the audible range (approximately 100% above 1.4 kHz), which is significantly higher than the absorption coefficient of benchmarking glass wool and porous foams in industry.

### Example 3

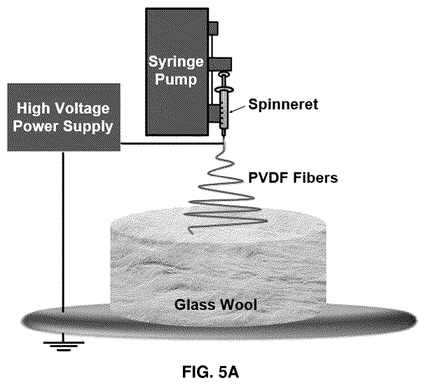

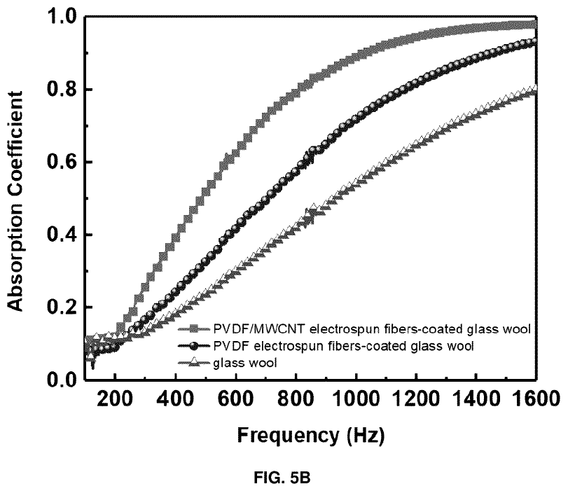

Referring now to FIG. 5A, a fabrication method for a PVDF electrospun fibre-coated glass wool porous composite is shown. An electrospinning technique was used to deposit PVDF or PVDF/MWCNT electrospun fibres on a porous glass wool sample as shown in FIG. 5A.

A polymer solution containing the negative triboelectric PVDF was prepared by dissolving 5 wt % PVDF in a mixed DMF and acetone solvent (50:50 by volume) in a silicone oil bath at 60° C. MWCNTs with a concentration of 7 wt % (in the solid PVDF powder) were added to the polymer solution to satisfy the percolation threshold.

A spinneret containing the PVDF solution was used to deposit the PVDF electrospun fibres. A high voltage power supply was used at 1.5 kV/cm between a tip of the spinneret containing the PVDF solution and the grounded glass wool sample. A continuous fine jet of the polymer solution was ejected from the spinneret and moved through the electric field to be deposited on the grounded glass wool sample which was flipped on all sides every 30 minutes to allow the fine PVDF electrospun fibres to diffuse inside its porosity and cover whole surfaces.

The PVDF electrospun fibre-coated glass wool was then annealed at 135° C. for 24 hours.

This method is scalable at low cost by eliminating the amount of polymer solution used for the immersion process as described in Example 2 and water used for leaching the salt as described in Example 1.

Referring now to FIG. 5B, sound absorption coefficients of the porous composites were measured according to the ASTM E1050-19 procedure utilizing a standard acoustic tube (Bruel & Kjaer) with a sample thickness of 25 mm and diameter of 100 mm. The acoustic absorption coefficients of the glass wool coated with PVDF electrospun fibres and PVDF/MWCNT electrospun fibres were compared to that of a glass wool acoustic absorber sample. As can be seen from FIG. 5B, the acoustic absorption coefficient of PVDF/MWCNT electrospun fibre-coated glass wool is the highest and is able to reach more than 50% at frequencies higher than 450 Hz in the audible range (approximately 100% above 1.4 kHz), which is significantly higher than the absorption coefficient of the benchmarking glass wool and porous foams in industry. The piezoelectric PVDF electrospun fibres act as a negative triboelectric material, while the glass wool acts as a positive triboelectric material. The excitation from airborne acoustic waves causes mechanical vibrations with relative movement between the PVDF electrospun fibres and the glass wool leading to contact electrification which can generate charges through the triboelectric effect, and electrical discharge can happen through the conductive MWCNT network.

### Example 4

An electrospinning technique was used to deposit polystyrene (PS) or PS/MWCNT electrospun fibres on a porous glass wool sample.

A polymer solution containing the negative triboelectric PS was prepared by dissolving 15 wt % PS in a DMF solvent in a silicone oil bath at 50° C. MWCNTs with a concentration of 5 wt % (in the solid PS powder) were added to the polymer solution.

A spinneret containing PS or PS/MWCNT suspension was used to fabricate the PS or PS/MWCNT electrospun fibres. A high voltage was used at 2 kV/cm between a tip of the spinneret containing the polymer solution and the grounded glass wool sample. A continuous fine jet of the polymer solution was ejected from the spinneret and moved through the electric field to be deposited on the grounded glass wool sample which was flipped on all sides every 30 minutes to allow the fine electrospun fibres to diffuse into its porous structure and to cover whole surfaces.

The PS electrospun fibre-coated glass wool was then annealed at 90° C. for 2 hours.

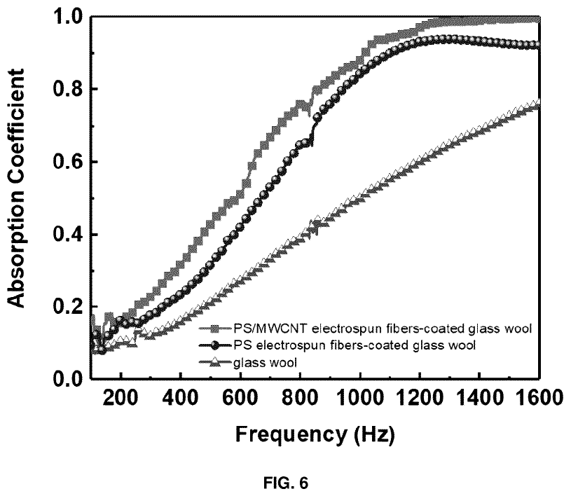

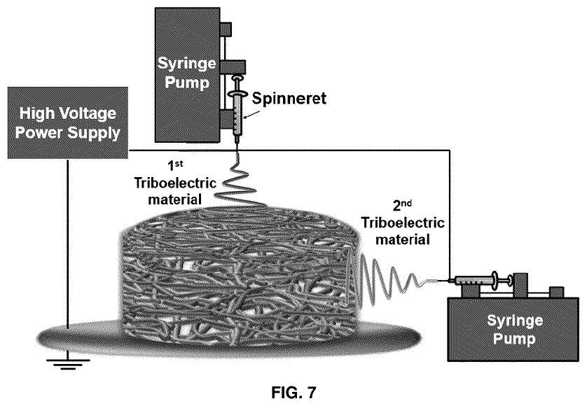

Referring now to FIG. 6, sound absorption coefficients of the porous composites were measured according to the ASTM E1050-19 procedure utilizing a standard acoustic tube (Bruel & Kjaer) with a sample thickness of 25 mm and diameter of 100 mm. The acoustic absorption coefficients of the glass wool coated with PS electrospun fibres and PS/MWCNT electrospun fibres compared to a glass wool acoustic absorber sample are shown in FIG. 6. The acoustic absorption coefficient of PS/MWCNT electrospun fibre-coated glass wool is the highest and is able to reach more than 50% at frequencies higher than 550 Hz in the audible range (approximately 100% above 1.2 kHz), which is significantly higher than the absorption coefficient of the benchmarking glass wool and porous foams in industry. The PS electrospun fibres act as a negative triboelectric material, while the glass wool acts as a positive triboelectric material. Excitation from airborne acoustic waves causes mechanical vibrations with relative movement between the PS electrospun fibres and the glass wool leading to contact electrification, which can generate charges through the triboelectric effect, and electrical discharge can happen through the conductive MWCNT network.

### Example 5

Referring now to FIG. 7, an electrospinning technique using two (2) spinnerets to deposit two (2) triboelectric fibre materials is shown. A high voltage power supply is used between tips of the two (2) spinnerets containing two polymer solutions and a grounded substrate. Continuous jets of the polymer solutions ejected from the spinnerets and moved through the electric field are deposited on the grounded substrate to accumulate fibres of the two triboelectric materials.

The experimental results demonstrated a significant advantage of using porous composites made of triboelectric materials with or without conducting materials that absorb more than 50% at frequencies higher than 450 Hz in the audible range (approximately 100% above 1.4 kHz), which is significantly higher than the absorption coefficient of the benchmarking porous foams in industry.

Use of triboelectrification phenomenon for acoustic energy dissipation, noise mitigation or sound absorption has been demonstrated.

Additionally, it has also been demonstrated that triboelectric materials with electrically conductive materials can be used to effectively dissipate airborne sound energy for noise mitigation applications through a conductive network introduced to convert the generated electrical energy into thermal dissipation.

As is evident from the foregoing discussion, the present invention provides a triboelectric porous composite for airborne acoustic absorption and a method of fabricating a porous composite for airborne acoustic absorption. The porous composite for airborne acoustic absorption of the present invention includes at least two types of triboelectric materials with substantially different charge affinities homogenously mixed for enhancing conversion of mechanical energy in the acoustic wave to electrical energy through triboelectric effect, which may be thermally dissipated through addition of an electrically conducting material. The porous triboelectric composite of the present invention provides relative movements of the triboelectric materials from excitation of airborne acoustic waves that makes mechanical vibrations in the porous structure, which undergoes electromechanical energy conversion and acoustic absorption through the triboelectric effect. Advantageously, the sound absorption material of the present invention provides improved ability in airborne sound absorption at lowered cost and simplified process for practical implementation, improved material performance for passive sound absorption at low frequency range, particularly effective in absorbing sounds below 1000 Hz, and a wide range of material pair selection with triboelectric effect. Fabrication methods of the present invention involve steps of preparing precursor solutions or suspensions of triboelectric materials and conductive materials in a mixed solvent and preparing a porous composite structure from the precursor solution or suspension by salt/sugar template, immersion, or electrospinning techniques. Advantageously, the fabrication methods of the present invention scalable for industry.

The sound absorption material of the present invention may be applied in noise mitigation applications inside buildings and for industrial machines, home appliances, vehicles, noise barriers and high-quality audio devices and instruments.

While preferred embodiments of the invention have been described, it will be clear that the invention is not limited to the described embodiments only. Numerous modifications, changes, variations, substitutions and equivalents will be apparent to those skilled in the art without departing from the scope of the invention as described in the claims.

Further, unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A sound absorption material, comprising:
a porous structure, comprising:
a hybrid composite of a first triboelectric material having a first charge affinity and a second triboelectric material having a second charge affinity, wherein the first charge affinity is greater than the second charge affinity.

2. The sound absorption material of claim 1, wherein a difference between the first and second charge affinities is between about 10 nano-Coulomb per Joule (nC/J) and about 250 nC/J.

3. The sound absorption material of claim 21, wherein the difference between the first and second charge affinities is between about 200 nC/J and about 250 nC/J.

4. The sound absorption material of claim 1, wherein the first triboelectric material has a positive charge affinity and the second triboelectric material has a negative charge affinity.

5. The sound absorption material of claim 1, wherein at least one of the first and second triboelectric materials is a piezoelectric material.

6. The sound absorption material of claim 5, wherein the piezoelectric material is selected from a group consisting of a polyvinylidene fluoride (PVDF) homopolymer, a PVDF-based copolymer, poly(vinylidene fluoride trifluoroethylene), a poly(vinylidene fluoride-hexafluoropropylene) copolymer, poly(vinylidene fluoride-trifluoroethylene-chlorofluoroethylene) terpolymer, and poly(L-lactide) (PLLA).

7. The sound absorption material of claim 5, wherein a concentration of the piezoelectric material in the hybrid composite is between about 1 percentage by mass (wt %) and about 25 wt % of the hybrid composite.

8. The sound absorption material of claim 1, wherein the first triboelectric material is selected from a group consisting of polymethyl methacrylate (PMMA), poly(L-lactide) (PLLA), polycarbonate (PC), polyurethane (PU), poly[imino(1,6-dioxohexamethylene) iminohexamethylene], cotton, and glass wool.

9. The sound absorption material of claim 1, wherein the second triboelectric material is selected from a group consisting of polyimide (PI), polystyrene (PS), polypropylene (PP), polyethylene (PE), polyacrylonitrile (PAN), polyvinylpyrrolidone (PVP), polyvinyl chloride (PVC), and polyvinylidene fluoride (PVDF).

10. The sound absorption material of claim 1, wherein the first and second triboelectric materials are a triboelectric pair selected from a group consisting of PVDF-glass wool, PVDF-poly[imino(1,6-dioxohexamethylene) iminohexamethylene], PVDF-PE, PVDF-PP, PVDF-PLLA, PVDF-PMMA, PVC-glass wool, PVC-poly[imino(1,6-dioxohexamethylene) iminohexamethylene], PVC-PU, PVC-PE, PVC-PP, PVC-PLLA, PVC-PMMA, PVA-glass wool, PVA-poly[imino(1,6-dioxohexamethylene) iminohexamethylene], PVA-PU, PVA-PE, PVA-PP, PVA-PLLA, PVA-PMMA, PAN-glass wool, PAN-poly[imino(1,6-dioxohexamethylene) iminohexamethylene], PAN-PU, PAN-PE, PAN-PP, PAN-PLLA, PAN-PMMA, PS-glass wool, PS-poly[imino(1,6-dioxohexamethylene) iminohexamethylene], PS-PU, PS-PE, PS-PP, PS-PLLA, PS-PMMA, PC-glass wool, PC-poly[imino(1,6-dioxohexamethylene) iminohexamethylene], PC-PU, PC-PE, PC-PP, PC-PLLA, PC-PMMA, PI-glass wool, PI-poly[imino(1,6-dioxohexamethylene) iminohexamethylene], PI-PU, PI-PE, PI-PP, PI-PLLA, PI-PMMA, glass wool-PP, and poly[imino(1,6-dioxohexamethylene) iminohexamethylene]-PP.

11. The sound absorption material of claim 1, wherein the hybrid composite further comprises an electrically conductive material providing an electrically conductive network within the porous structure.

12. The sound absorption material of claim 11, wherein the electrically conductive material is one or more selected from a group consisting of single-walled carbon nanotubes (SWCNTs), multi-walled carbon nanotubes (MWCNTs), graphene, carbon black, silver nanowires and metal particles.

13. The sound absorption material of claim 11, wherein a concentration of the electrically conductive material in the hybrid composite is at or above a percolation threshold.

14. The absorption material of claim 13, wherein the concentration of the electrically conductive material in the hybrid composite is between about 3 percentage by mass (wt %) and about 9 wt % of the first and second triboelectric materials.

15. The sound absorption material of claim 1, wherein a sound absorption coefficient of the hybrid composite as measured according to an ASTM E1050-19 procedure utilizing a standard acoustic tube (Bruel & Kjaer) with a sample thickness of 25 millimetres (mm) and diameter of 100 mm is greater than about 50% at frequencies higher than between about 550 Hertz (Hz) and about 570 Hz in an audible range.

16. The sound absorption material of claim 15, wherein the sound absorption coefficient of the hybrid composite as measured according to the ASTM E1050-19 procedure utilizing the standard acoustic tube (Bruel & Kjaer) with the sample thickness of 25 millimetres (mm) and diameter of 100 mm is greater than about 90% at frequencies higher than 1 kiloHertz (kHz) in the audible range.

17. The sound absorption material of claim 1, wherein a concentration of one of the first and second triboelectric materials in the hybrid composite is between about 1 wt % and about 25 wt % of the hybrid composite.

18. A method of fabricating a sound absorption material, comprising:
preparing a first precursor solution or suspension of one of a first triboelectric material and a second triboelectric material; and
forming a porous structure by using the first precursor solution or suspension in one of a templating technique with a second precursor solution or suspension of the other one of the first and second triboelectric material, an immersion technique with the other one of the first and second triboelectric materials, and an electrospinning technique with the other one of the first and second triboelectric materials, wherein the porous structure comprises:
a hybrid composite of the first triboelectric material having a first charge affinity and the second triboelectric material having a second charge affinity, wherein the first charge affinity is greater than the second charge affinity.

19-28. (canceled)

29. The method of fabricating a sound absorption material of claim 18, wherein the step of forming the porous structure using the first precursor solution or suspension in the templating technique with a second precursor solution or suspension of the other one of the first and second triboelectric material comprises:
preparing the second precursor solution or suspension of the other one of the first triboelectric material and the second triboelectric material;
mixing the first precursor solution or suspension and the second precursor solution or suspension to form a first mixture;
mixing a porogen into the first mixture to form a second mixture;
performing a moulding operation using the second mixture to produce the hybrid composite; and
dissolving the porogen to obtain the porous structure.

30-32. (canceled)

33. The method of fabricating a sound absorption material of claim 18, wherein the step of forming the porous structure using the first precursor solution or suspension in the electrospinning technique with the other one of the first and second triboelectric materials comprises:
electrospinning the first precursor solution or suspension to generate a plurality of first electrospun fibres; and
depositing the first electrospun fibres through an electric field onto the other one of the first and second triboelectric materials to cover a plurality of surfaces of the other one of the first and second triboelectric materials, the first electrospun fibres diffusing into a plurality of pores of the other one of the first and second triboelectric materials.

34-35. (canceled)
